(19) United States
(12) Patent Application Publication
(10) Pub. No.: US 2021/0301843 A1
(43) Pub. Date: Sep. 30, 2021

(54) MACHINE AND AUXILIARY HYDRAULIC PUMP ASSOCIATED WITH MACHINE

(71) Applicant: Caterpillar Paving Products Inc., Brooklyn Park, MN (US)

(72) Inventor: Steven Goutemont, Saint Michael, MN (US)

(73) Assignee: Caterpillar Paving Products Inc., Brooklyn Park, MN (US)

(21) Appl. No.: 16/835,439

(22) Filed: Mar. 31, 2020

(51) Int. Cl. F15B 21/08; E01C 19/48

(52) U.S. Cl. CPC F15B 21/08; E01C 19/48

(57) ABSTRACT

A machine is provided. The machine includes a frame. The machine also includes an engine mounted on the frame. The machine further includes a battery system mounted on the frame. The battery system is adapted to output power. The machine includes an auxiliary hydraulic pump supported by the frame and adapted to receive the power from the battery system for an operation thereof. The auxiliary hydraulic pump is activated based on receipt of an input signal for controlling a function of at least one machine component, and wherein the input signal is provided based on a failure of the engine.

### TECHNICAL FIELD

The present disclosure relates to a machine and an auxiliary hydraulic pump for the machine.

### BACKGROUND

A paving machine includes various machine components, such as a screed assembly and an auger for performing a paving operation, a steering system for steering the paving machine, machine brakes to stop or halt the paving machine, and a canopy disposed over a machine operator station. Such machine components of the paving machine are typically operated by a hydraulic system that includes a pump. The pump is in turn driven by an engine of the paving machine.

During operation, if the engine stops operating due to a failure situation, the paving machine may have to be towed for servicing thereof. However, such an engine failure may cause the pump to lose incoming power which eventually causes stalling of the components that are operated by the pump. In some examples, due to abrupt stopping of the paving machine, the machine components may be in a state or position that makes it difficult to tow the paving machine. For example, an operator of the paving machine may not be able to raise or lower a screed plate of the screed assembly or the auger. Moreover, the operator may not be able to retract screed extenders of the screed assembly, release the machine brakes, steer the paving machine, or lower the canopy in order to tow the paving machine.

In some situations, the operator may have to manually perform certain operations so that the paving machine can be towed. For example, the operator may have to open the hydraulic system of the paving machine to manually lift, retract, or release the machine brakes. Opening of the paving machine may cause contamination of the hydraulic system and may also cause injuries to the operator/servicing personnel. Further, such a technique of manually operating the machine components is typically a laborious and time consuming job.

JP Patent Application Number 2010101141 describes a road paving machine. A power generation control device in the road paving machine includes a hydraulic pump driven by an engine for a vehicle, a power generation motor driven by the hydraulic pump and a generator rotated by the driving force from the power generation motor for generating power.

### SUMMARY OF THE DISCLOSURE

In an aspect of the present disclosure, a machine is provided. The machine includes a frame. The machine also includes an engine mounted on the frame. The machine further includes a battery system mounted on the frame. The battery system is adapted to output power. The machine includes an auxiliary hydraulic pump supported by the frame and adapted to receive the power from the battery system for an operation thereof. The auxiliary hydraulic pump is activated based on receipt of an input signal for controlling a function of at least one machine component. The input signal is provided based on a failure of the engine.

In another aspect of the present disclosure, a method of controlling a function of at least one machine component associated with a machine is provided. The method includes positioning an auxiliary hydraulic pump on a frame of the machine. The method also includes providing an input signal for activating the auxiliary hydraulic pump based on a failure of an engine of the machine. The auxiliary hydraulic pump operates based on receipt of power from a battery system of the machine. The method further includes coupling the auxiliary hydraulic pump with the at least one machine component to provide operational power to the at least one machine component based on an operation of the auxiliary hydraulic pump. The method includes controlling the function of the at least one machine component based on receipt of the operational power by the at least one machine component.

Other features and aspects of this disclosure will be apparent from the following description and the accompanying drawings.

### BRIEF DESCRIPTION OF THE DRAWINGS

FIG. 1 is a perspective view of a machine, according to one embodiment of the present disclosure;

FIG. 2 is a block diagram illustrating an auxiliary hydraulic pump, a battery system, and a mechanical input device for connecting the auxiliary hydraulic pump with the battery system, according to one embodiment of the present disclosure;

FIG. 3 is a block diagram illustrating the auxiliary hydraulic pump, the battery system, and a control module for connecting the auxiliary hydraulic pump with the battery system, according to one embodiment of the present disclosure; and

FIG. 4 is a flowchart for a method of operating the auxiliary hydraulic pump, according to one embodiment of the present disclosure

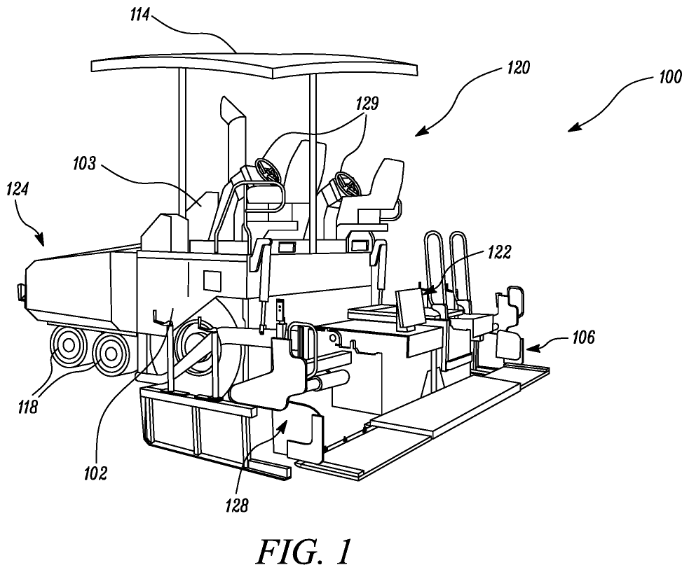

### DETAILED DESCRIPTION

Wherever possible, the same reference numbers will be used throughout the drawings to refer to the same or like parts. Referring to FIG. 1, an exemplary machine 100 is illustrated. The machine 100 is embodied as a paving machine herein. Alternatively, the machine 100 may embody another machine, such as, a rotary mixer, a cold planer, a loader, an excavator, a dump/haul truck, and the like. The machine 100 includes a frame 102. The frame 102 supports various components of the machine 100 thereon.

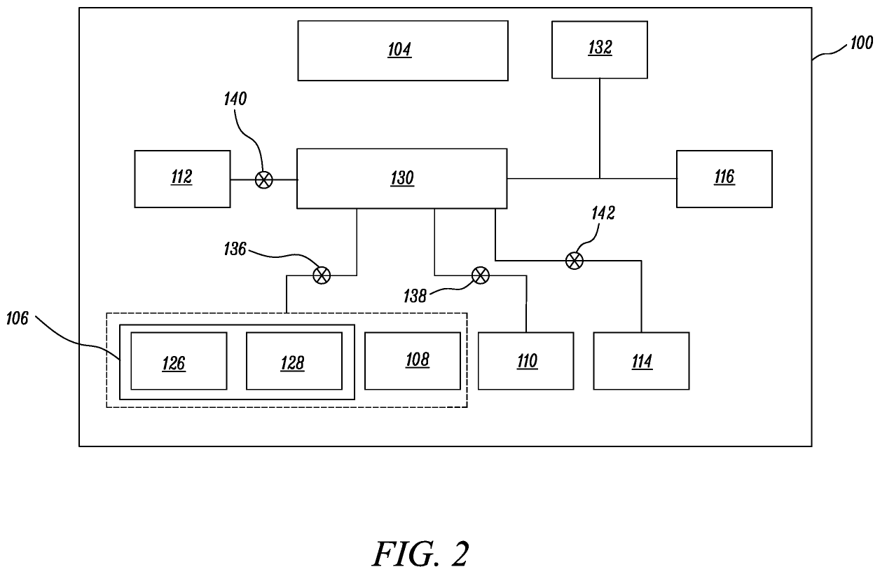

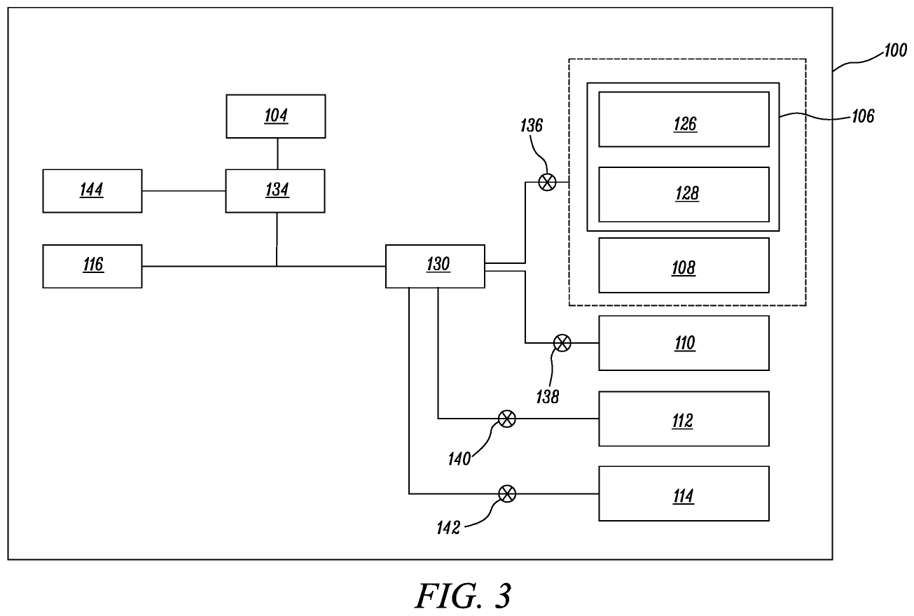

The machine 100 includes an enclosure 103 mounted on the frame 102. The enclosure 103 encloses an engine 104 (schematically shown in FIGS. 2 and 3). The engine 104 may be an internal combustion engine. The engine 104 provides power to the machine 100 for operational and mobility requirements. Further, the engine 104 also powers various components of the machine 100, such as a main pump, which may in turn operate other machine components, such as a screed assembly 106, an auger 108 (schematically shown in FIGS. 2 and 3), a steering system 110 (schematically shown in FIGS. 2 and 3), machine brakes 112 (schematically shown in FIGS. 2 and 3), and/or a canopy 114 of the machine 100. The main pump directs hydraulic fluid towards one or more components of the machine 100 when the engine 104 is in operation.

The machine 100 also includes a battery system 116 mounted on the frame 102. The battery system 116 outputs power. More particularly, the battery system 116 outputs Direct Current (DC) power of 12 Volts or 24 Volts. The power may be supplied to various electrical components of the machine 100 for operation thereof. The machine 100 includes the steering system 110 for steering of the machine 100.

The machine 100 also includes a set of ground engaging members 118. The ground engaging members 118 are operably coupled to the frame 102. In the illustrated embodiment, the ground engaging members 118 includes wheels. Alternatively, the ground engaging members 118 may be embodied as tracks. The ground engaging members 118 support and provide maneuverability to the machine 100 on a ground surface. Further, the machine 100 includes the machine brakes 112. The machine brakes 112 allow halting or slowing of the machine 100, as per requirements. It should be noted that the term “machine brakes 112” is used in a generic sense herein. In actual implementation, the machine 100 includes a drive planetary arrangement having a brake release piston, a number of discs, and a number of plates that operate to stop or halt the machine 100, without limiting the scope of the present disclosure.

The machine 100 also includes a machine operator station 120 mounted on the frame 102. The machine operator station 120 includes the canopy 114 that can be extended when the machine 100 is in operation and retracted when the machine 100 is shut down. The canopy 114 may be operated by a hydraulic actuator (not shown) that allows extension and/or retraction of the canopy 114. The machine operator station 120 may further include one or more seats for an operator. Further, the machine operator station 120 may include various input devices, such as a user interface 144 (shown in FIG. 3), switches, knobs, buttons, joysticks, levers, and the like. The input devices may allow operation and control of the machine 100. The machine operator station 120 also includes a brake pedal (not shown) that is used for applying the machine brakes 112 and one or more steering wheels 129 to provide a steering input to the steering system 110. The machine 100 includes a screed operator station 122. The screed operator station 122 allows control of various functions associated with the screed assembly 106 of the machine 100.

The machine 100 also includes a hopper assembly 124 operably coupled to the frame 102. The hopper assembly 124 holds a volume of paving material on the machine 100 received from an external source (not shown), such as a truck or a transfer vehicle, for example. The hopper assembly 124 also transfers the paving material towards the auger 108 of the machine 100. The auger 108 is operated by a hydraulic actuator. The auger 108 may be raised or lowered relative to the frame 102 based on operation of the hydraulic actuator. The auger 108 evenly distributes the paving material in front of the screed assembly 106.

Further, the screed assembly 106 includes a screed 126 that spreads and compacts the paving material deposited on the ground surface. The screed 126 may be raised or lowered relative to the frame 102 based on operation of a hydraulic actuator. The screed 126 includes a screed frame (not shown) and a screed plate (not shown) mounted on the screed frame. The screed plate compacts the paving material deposited on the ground surface. Specifically, the screed plate contacts the paving material deposited on the ground surface to level the deposited paving material with respect to the ground surface. In an embodiment, the screed assembly 106 additionally includes a pair of screed extenders 128. Each screed extender 128 is moveably coupled to the screed frame. The screed extenders 128 may be extended or retracted relative to the frame 102 based on operation of corresponding hydraulic actuators. The screed extenders 128 may contact the paving material deposited on the ground surface in association with the screed 126 for leveling the deposited paving material with respect to the ground surface.

The machine 100 also includes an auxiliary hydraulic pump 130 supported by the frame 102. The auxiliary hydraulic pump 130 is embodied as a DC hydraulic pump. The auxiliary hydraulic pump 130 receives power from the battery system 116 for an operation thereof. More particularly, the battery system 116 is connected to the auxiliary hydraulic pump 130 to supply the power to the auxiliary hydraulic pump 130. The battery system 116 may supply the DC power of 12 Volts or 24 Volts to the auxiliary hydraulic pump 130, as per requirements. The auxiliary hydraulic pump 130 includes a motor, such as a DC motor, that receives the DC power from the battery system 116 for operating the auxiliary hydraulic pump 130.

The auxiliary hydraulic pump 130 is activated based on receipt of an input signal for controlling a function of one or more machine components 106, 108, 110, 112, 114. It should be noted that the input signal is provided based on a failure of the engine 104. More particularly, the auxiliary hydraulic pump 130 is activated based on the failure of the engine 104 to power the screed assembly 106, the auger 108, the steering system 110, the canopy 114, and/or the machine brakes 112. Further, the input signal is provided by the operator of the machine 100.

The auxiliary hydraulic pump 130 provides operational power to the one or more machine components 106, 108, 110, 112, 114 based on the operation thereof. In the illustrated example, the machine components 106, 108, 110, 112, 114 include the screed assembly 106, the auger 108, the steering system 110, the machine brakes 112, and the canopy 114. As mentioned earlier, the auxiliary hydraulic pump 130 controls the function of one or more machine components 106, 108, 110, 112, 114. In an example, the function includes moving one or more components of the screed assembly 106 and the auger 108 based on the operation of the auxiliary hydraulic pump 130. The one or more components of the screed assembly 106 includes the screed 126 and the screed extenders 128. In another example, the function includes moving the canopy 114 based on the operation of the auxiliary hydraulic pump 130. In yet another example, the function includes steering the machine 100, via the steering system 110, based on the operation of the auxiliary hydraulic pump 130. Further, in an example, the function includes releasing the machine brakes 112 based on the operation of the auxiliary hydraulic pump 130. Alternatively, the auxiliary hydraulic pump 130 may provide the operational power to any other component of the machine 100, as per requirements.

It should be noted that an isolation valve (not shown) is associated with the machine 100. The isolation valve can be turned on for isolating one or more components of the machine 100 from the main pump. In the illustrated example, when the engine 104 fails, the isolation valve allows isolation of the screed assembly 106, the auger 108, the steering system 110, the machine brakes 112, and/or the canopy 114 from the main pump. This way, the auxiliary hydraulic pump 130 may be used to provide the operational power to the machine components 106, 108, 110, 112, 114. Further, the input signal is provided to a mechanical input device 132 or a control module 134. More particularly, the operator may provide the input signal to the mechanical input device 132 or the control module 134, as per application requirements.

FIG. 2 illustrates a block diagram for a first embodiment wherein the input signal for activating the auxiliary hydraulic pump 130 is provided to the mechanical input device 132. The input signal is provided to the mechanical input device 132 based on the failure of the engine 104. Further, the mechanical input device 132 is provided on the frame 102 and is proximate to a location of the auxiliary hydraulic pump 130. In an example, the mechanical input device 132 is embodied as a switch that may be flipped to provide the input signal. Alternatively, the mechanical input device 132 may include a button, a knob, a lever, or any other such device.

When activated, the mechanical input device 132 connects the auxiliary hydraulic pump 130 to the battery system 116 so that the power can be supplied to the auxiliary hydraulic pump 130. The operation of the auxiliary hydraulic pump 130 causes hydraulic fluid to flow towards hydraulic devices associated with the corresponding machine components 106, 108, 110, 112, 114. In the illustrated example, the auxiliary hydraulic pump 130 provides the operational power to the screed assembly 106, the auger 108, the steering system 110, the canopy 114, and/or the machine brakes 112.

It should be noted that the auxiliary hydraulic pump 130 selectively provides the operational power to the one or more machine components 106, 108, 110, 112, 114. More particularly, the auxiliary hydraulic pump 130 may individually control the machine components 106, 108, 110, 112, 114, based on requirements. For this purpose, the machine 100 may include a number of valves provided between the auxiliary hydraulic pump 130 and the machine components 106, 108, 110, 112, 114. Such valves may connect or disconnect the auxiliary hydraulic pump 130 with the respective machine components 106, 108, 110, 112, 114.

For example, a first valve 136 may allow or restrict fluid connection of the auxiliary hydraulic pump 130 with the screed assembly 106 and the auger 108. In an example, the first valve 136 may be mechanically actuated by the operator. In another example, the first valve 136 may be a solenoid valve. The first valve 136 may be activated by a switch associated therewith. When the auxiliary hydraulic pump 130 is in operation and the first valve 136 is activated, the operational power is supplied to each of the screed assembly 106 and the auger 108. More particularly, hydraulic fluid is directed to the hydraulic actuators associated with the screed 126 and the screed extenders 128 in order to retract the screed 126 and the screed extenders 128. Further, hydraulic fluid is directed to the hydraulic actuator associated with the auger 108 in order to retract the auger 108.

Further, a second valve 138 may allow or restrict fluid connection of the auxiliary hydraulic pump 130 with the steering system 110. In an example, the second valve 138 may be mechanically actuated by the operator. In another example, the second valve 138 may be a solenoid valve. The second valve 138 may be activated by a switch associated therewith. When the auxiliary hydraulic pump 130 is in operation and the second valve 138 is activated, the operational power is supplied to the steering system 110. More particularly, hydraulic fluid may be directed towards the steering system 110 in order to steer the machine 100.

Moreover, a third valve 140 may allow or restrict fluid connection of the auxiliary hydraulic pump 130 with the machine brakes 112. In an example, the third valve 140 may be mechanically actuated by the operator. In another example, the third valve 140 may be a solenoid valve. The third valve 140 may be activated by a switch associated therewith. When the auxiliary hydraulic pump 130 is in operation and the third valve 140 is activated, the operational power is supplied to the machine brakes 112. More particularly, hydraulic fluid may be directed towards the drive planetary arrangement to pressurize the break release piston disposed inside the drive planetary arrangement to separate the discs and the plates within the drive planetary arrangement. Further, the hydraulic fluid may maintain a hydraulic pressure within the drive planetary arrangement until the machine 100 is towed.

Further, a fourth valve 142 may allow or restrict fluid connection of the auxiliary hydraulic pump 130 with the canopy 114. In an example, the fourth valve 142 may be mechanically actuated by the operator. In another example, the fourth valve 142 may be a solenoid valve. The fourth valve 142 may be activated by a switch associated therewith. When the auxiliary hydraulic pump 130 is in operation and the fourth valve 142 is activated, the operational power is supplied to the canopy 114. More particularly, hydraulic fluid may be directed towards the hydraulic actuator associated with the canopy 114 in order to retract the canopy 114. In some examples, the first, second, third, and/or fourth valves 136, 138, 140, 142 may be located proximate to the mechanical input device 132 or proximate to the auxiliary hydraulic pump 130.

FIG. 3 illustrates a block diagram for a second embodiment wherein the input signal for activating the auxiliary hydraulic pump 130 is provided to the control module 134. The input signal is provided to the control module 134 based on the failure of the engine 104. In an example, the operator provides the input signal to the control module 134 via the user interface 144 positioned within the machine operator station 120. More particularly, the user interface 144 may present a control menu (not shown) thereon. The control menu may in turn include a dedicated icon to provide the input signal to the control module 134. When the operator provides an input to the dedicated icon, the control module 134 may receive the input signal. The user interface 144 may be a touchscreen or the user interface 144 may embody another type of device that includes buttons to select and navigate through various machine functions. In other examples, the user interface 144 may embody a push button, a switch, a knob, a lever, and the like, that provides the input signal to the control module 134.

Further, the control module 134 receives the input signal for activating the auxiliary hydraulic pump 130. The control module 134 connects the battery system 116 with the auxiliary hydraulic pump 130 based on receipt of the input signal. More particularly, the control module 134 may send a control signal for connection of the battery system 116 with the auxiliary hydraulic pump 130. In one example, the control module 134 also determines if the engine 104 is in a non-operational state before connecting the battery system 116 with the auxiliary hydraulic pump 130. In some examples, the control module 134 may also be programmed to operate the isolation valve based on the receipt of the input signal in order to isolate the screed assembly 106, the auger 108, the steering system 110, the machine brakes 112, and/or the canopy 114 from the main pump of the machine 100.

Further, once the auxiliary hydraulic pump 130 starts operating, the first, second, third, and/or fourth valves 136, 138, 140, 142 may be activated by the operator via dedicated input devices (not shown) present in the machine operator station 120. The dedicated input devices may embody buttons, switches, levers, knobs, and the like. Thus, once the auxiliary hydraulic pump 130 starts operating, the activation of the first, second, third, and/or fourth valves 136, 138, 140, 142 using the dedicated input devices may in turn cause the one or more machine components 106, 108, 110, 112, 114 to operate.

In another example, the first, second, third, and/or fourth valves 136, 138, 140, 142 may be activated via the control module 134. In such an example, the operator may provide inputs to the control module 134 via the user interface 144 for activation of the first, second, third, and/or fourth valves 136, 138, 140, 142. Once the auxiliary hydraulic pump 130 starts operating and the one or more valves 136, 138, 140, 142 are activated, the functions related to the screed assembly 106, the auger 108, the steering system 110, the machine brakes 112, and/or the canopy 114, respectively, may be controlled. It should be noted that details pertaining to the functioning of the auxiliary hydraulic pump 130 for controlling the machine components 106, 108, 110, 112, 114 explained in relation to the first embodiment illustrated in FIG. 2 is equally applicable to the second embodiment, without any limitations.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

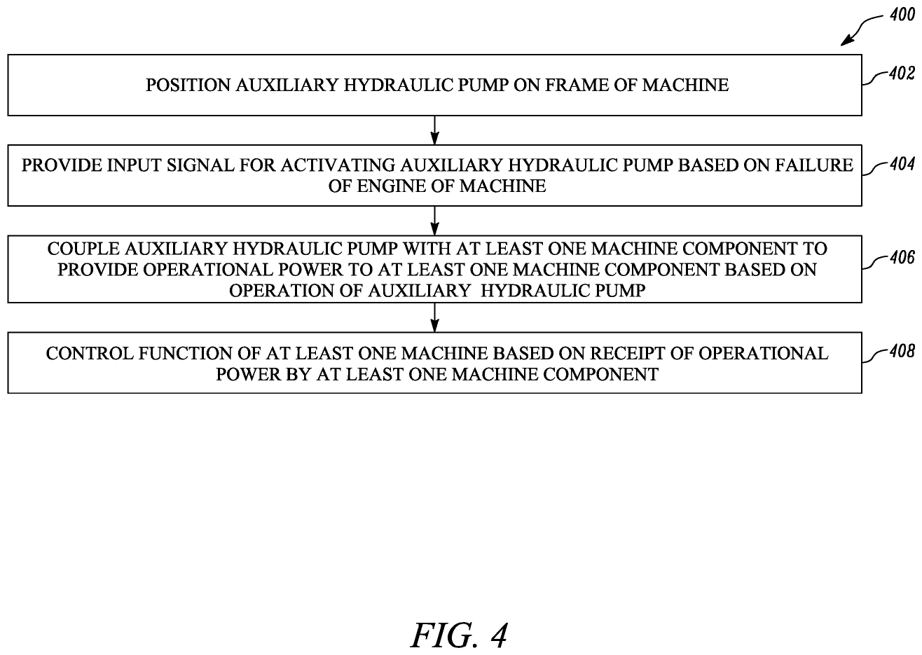

FIG. 4 illustrates a method 400 of controlling the function of one or more machine components 106, 108, 110, 112, 114 associated with the machine 100. At step 402, the auxiliary hydraulic pump 130 is positioned on the frame 102 of the machine 100. At step 404, the input signal is provided for activating the auxiliary hydraulic pump 130 based on the failure of the engine 104 of the machine 100. The auxiliary hydraulic pump 130 operates based on receipt of power from the battery system 116 of the machine 100. Further, the input signal is provided by the operator of the machine 100. The input signal is provided to the mechanical input device 132 or the control module 134.

At step 406, the auxiliary hydraulic pump 130 is coupled with the one or more machine components 106, 108, 110, 112, 114 to provide the operational power to the one or more machine components 106, 108, 110, 112, 114 based on the operation of the auxiliary hydraulic pump 130. In an example, the input signal for activating the auxiliary hydraulic pump 130 is received by the control module 134. Further, the control module 134 connects the battery system 116 with the auxiliary hydraulic pump 130 based on receipt of the input signal. At step 408, the function of the one or more machine components 106, 108, 110, 112, 114 is controlled based on receipt of the operational power by the one or more machine components 106, 108, 110, 112, 114. In some examples, the auxiliary hydraulic pump 130 selectively provides the operational power to the number of machine components 106, 108, 110, 112, 114.

Further, in an example, the step of controlling the function includes moving one or more components 126, 128 of the screed assembly 106 of the machine 100 and the auger 108 of the machine 100 based on the operation of the auxiliary hydraulic pump 130. In another example, the step of controlling the function includes moving the canopy 114 of the machine 100 based on the operation of the auxiliary hydraulic pump 130. In yet another example, the step of controlling the function includes operating the steering system 110 of the machine 100 for steering the machine 100 based on the operation of the auxiliary hydraulic pump 130. Further, the step of controlling the function includes releasing the machine brakes 112 based on the operation of the auxiliary hydraulic pump 130.

The auxiliary hydraulic pump 130 disclosed herein is operated based on the power received from the battery system 116, and hence the auxiliary hydraulic pump 130 can be activated even if the engine 104 fails. Thus, in an event of the failure of the engine 104, the operator may activate the auxiliary hydraulic pump 130 by providing the input signal to the mechanical input device 132 or the control module 134. Further, the auxiliary hydraulic pump 130 can be activated by the mechanical input device 132 or the control module 134, thereby ensuring a backup system in an event of failure of the mechanical input device 132 or the control module 134.

When the engine 104 fails, the auxiliary hydraulic pump 130 can be used as a power source for operating the screed assembly 106, the auger 108, the steering system 110, the machine brakes 112, and/or the canopy 114. Accordingly, the screed assembly 106, the auger 108, the steering system 110, the machine brakes 112, and/or the canopy 114, may be operated to a state that allows easy towing of the machine 100. Thus, the machine 100 may be towed without repairing the engine 104.

Further, the present disclosure eliminates a need of opening a hydraulic system of the machine 100 by the operator for operating the machine components 106, 108, 110, 112, 114 to allow machine towing. Thus, a possibility of contamination of the hydraulic system and any probable injury to the operator/personnel is reduced. Also, the machine components 106, 108, 100, 112, 114 may be operated without repairing the engine 104 as the operation of the auxiliary hydraulic pump 104 is not dependent on the operation of the engine 104. Further, the teachings of the present disclosure can be extended to a variety of machines. The auxiliary hydraulic pump 130 may be retrofitted on existing machines with minimum modifications to the machine hardware of software.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof

What is claimed is:

1. A machine comprising:
a frame;
an engine mounted on the frame;
a battery system mounted on the frame, wherein the battery system is adapted to output power; and
an auxiliary hydraulic pump supported by the frame and adapted to receive power from the battery system for an operation thereof,
wherein the auxiliary hydraulic pump is activated based on receipt of an input signal for controlling a function of at least one machine component, and wherein the input signal is provided based on a failure of the engine.

2. The machine of claim 1, wherein the auxiliary hydraulic pump is adapted to provide operational power to the at least one machine component based on the operation thereof.

3. The machine of claim 1, wherein the input signal is provided by an operator of the machine.

4. The machine of claim 1, wherein the input signal is provided to at least one of a mechanical input device and a control module.

5. The machine of claim 4, wherein the control module is configured to:
receive the input signal for activating the auxiliary hydraulic pump; and
connect the battery system with the auxiliary hydraulic pump based on receipt of the input signal.

6. The machine of claim 1, wherein the auxiliary hydraulic pump is adapted to selectively provide operational power to a plurality of machine components.

7. The machine of claim 1, wherein the at least one machine component includes at least one of a screed assembly, an auger, a steering system, machine brakes, and a canopy.

8. The machine of claim 7, wherein the function includes moving at least one component of the screed assembly and the auger based on the operation of the auxiliary hydraulic pump.

9. The machine of claim 7, wherein the function includes moving the canopy based on the operation of the auxiliary hydraulic pump.

10. The machine of claim 7, wherein the function includes steering the machine, via the steering system, based on the operation of the auxiliary hydraulic pump.

11. The machine of claim 7 wherein the function includes releasing the machine brakes based on the operation of the auxiliary hydraulic pump.

12. A method of controlling a function of at least one machine component associated with a machine, the method comprising:
positioning an auxiliary hydraulic pump on a frame of the machine;
providing an input signal for activating the auxiliary hydraulic pump based on a failure of an engine of the machine, wherein the auxiliary hydraulic pump operates based on receipt of power from a battery system of the machine;
coupling the auxiliary hydraulic pump with the at least one machine component to provide operational power to the at least one machine component based on an operation of the auxiliary hydraulic pump; and
controlling the function of the at least one machine component based on receipt of the operational power by the at least one machine component.

13. The method of claim 12 further comprising providing the input signal by an operator of the machine.

14. The method of claim 12 further comprising providing the input signal to at least one of a mechanical input device and a control module.

15. The method of claim 14 further comprising:
receiving the input signal for activating the auxiliary hydraulic pump; and
connecting, the battery system with the auxiliary hydraulic pump based on receipt of the input signal.

16. The method of claim 12 further comprising selectively providing operational power, by the auxiliary hydraulic pump, to a plurality of machine components.

17. The method of claim 12, wherein the step of controlling the function includes moving at least one component of a screed assembly of the machine and an auger of the machine based on the operation of the auxiliary hydraulic pump.

18. The method of claim 12, wherein the step of controlling the function includes moving a canopy of the machine based on the operation of the auxiliary hydraulic pump.

19. The method of claim 12, wherein the step of controlling the function includes operating a steering system of the machine for steering the machine based on the operation of the auxiliary hydraulic pump.

20. The method of claim 12, wherein the step of controlling the function includes releasing machine brakes based on the operation of the auxiliary hydraulic pump.
